(19) United States
(12) Patent Application Publication
(10) Pub. No.: US 2011/0079349 A1
(43) Pub. Date: Apr. 7, 2011

(54) Method of manufacturing printed circuit board

(75) Inventors: Suk Hyeon Cho, Suwon-si (KR); Chang Sup Ryu, Yongin-si (KR); Jin Yong An, Yongin-si (KR); Soon Oh Jung, Suwon-si (KR); Sung Won Jeong, Yongin-si (KR); Byung Moon Kim, Suwon-si (KR); Dong Ju Jeon, Seoul (KR); Seok Kyu Lee, Suwon-si (KR); Jin Ho Kim, Yongin-si (KR)

(73) Assignee: SAMSUNG ELECTRO-MECHANICS CO., LTD., Suwon (KR)

(21) Appl. No.: 12/654,360

(22) Filed: Dec. 17, 2009

(30) Foreign Application Priority Data
Oct. 1, 2009 (KR) 10-2009-0093657

(51) Int. Cl. B32B 38/10; B32B 38/04

(52) U.S. Cl. 156/247

(57) ABSTRACT

The present invention provides a method of manufacturing a printed circuit board including the steps of: preparing a pair of raw materials, each formed by sequentially stacking a release film and a first insulating layer, and an adhesive layer, respectively; embedding the pair of raw materials, which are opposed to each other, in the adhesive layer while disposing the release films toward an inner layer; forming a second insulating layer, which has a via formed therethrough and a circuit pattern formed on an upper surface to be connected to the via, on the first insulating layer; cutting edge portions of the second and first insulating layers, the release film, and the adhesive layer; and removing the release film from the first insulating layer.

### CROSS-REFERENCE TO RELATED APPLICATIONS

This application claims the benefit of Korean Patent Application No. 10-2009-0093657 filed with the Korea Intellectual Property Office on Oct. 1, 2009, the disclosure of which is incorporated herein by reference.

### BACKGROUND OF THE INVENTION

1. Field of the Invention

The present invention relates to a method of manufacturing a printed circuit board, and more particularly, to a method of manufacturing a printed circuit board capable of manufacturing a coreless substrate by using a carrier in which a release film and an insulating layer are embedded in an adhesive layer.

2. Description of the Related Art

Sizes of components included in electronic products get smaller. Accordingly, a size of a package for mounting a device chip gets smaller, too. This requires that a substrate included in the package be thinner. Meanwhile, a small thickness of the substrate is an important factor to minimize loop inductance due to physical distance of a circuit.

In a conventional method of manufacturing a substrate, since a thickness of one circuit layer constituting the substrate does not have rigidity required for performing processes, the substrate having a core layer, which supports the substrate, is manufactured.

However, inclusion of the core layer in the substrate as a final product is a big obstacle to thickness reduction of the substrate, and a manufacturing cost is increased due to processes related to the core layer.

Accordingly, in the conventional method, a coreless substrate without a core layer is manufactured by separating a product from a carrier after manufacturing a printed circuit board having a multilayer circuit by applying an insulating layer on one surface of the carrier and repeatedly forming circuits and applying the insulating layers.

However, in order to separate the product from the carrier, the insulating layer, which covers a release film, is applied on the carrier after applying the release film, which covers a portion of a surface of the carrier, on the surface of the carrier. Since the release film has a thickness, cracks are generated in a corner portion of the release film due to thickness reduction of the insulating layer applied thereon. This causes separation of the release film during a substrate manufacturing process, and so there is a problem of deterioration of yield.

### SUMMARY OF THE INVENTION

The present invention has been proposed in order to solve the above-described problems, and it is, therefore, an object of the present invention to provide a method of manufacturing a printed circuit board capable of manufacturing a coreless substrate by using a carrier in which a release film and an insulating layer are embedded in an adhesive layer to prevent crack generation on the insulation layer formed on the release film and separation of the release film during a substrate manufacturing process, thereby improving manufacturing yield.

In accordance with an aspect of the present invention to achieve the object, there is provided a method of manufacturing a printed circuit board including the steps of: preparing a pair of raw materials, each formed by sequentially stacking a release film and a first insulating layer, and an adhesive layer, respectively; embedding the pair of raw materials, which are opposed to each other, in the adhesive layer while disposing the release films toward an inner layer; forming a second insulating layer, which has a via formed therethrough and a circuit pattern formed on an upper surface to be connected to the via, on the first insulating layer; cutting edge portions of the second and first insulating layers, the release film, and the adhesive layer; and removing the release film from the first insulating layer.

Here, the raw material may have a size smaller than that of the adhesive layer.

Further, the step of forming the second insulating layer, which has the via formed therethrough and the circuit pattern formed on the upper surface to be connected to the via, on the first insulating layer may further include the steps of: forming the second insulating layer on the first insulating layer; forming a via hole to open a portion of an upper substrate of the first insulating layer by removing a portion of the second insulating layer; forming the via by filling the via hole with metal; forming a conductive layer on the second insulating layer including the via; and forming the circuit pattern connected to the via by removing a portion of the conductive layer.

Further, after the step of removing the release film from the first insulating layer, the method may further include the steps of: forming a via hole to open the via by removing a portion of the first insulating layer corresponding to the via; and forming a surface-treated metal in the via opened by the via hole.

Further, the surface-treated metal may include Au.

In accordance with another aspect of the present invention to achieve the object, there is provided a method of manufacturing a printed circuit board including the steps of: preparing a pair of raw materials, each formed by sequentially stacking a release film, a first insulating layer, and a first conductive layer, and an adhesive layer, respectively; embedding the pair of raw materials, which are opposed to each other, in the adhesive layer while disposing the release films toward an inner layer; forming a first circuit pattern by removing a portion of the first conductive layer; forming a second insulating layer, which has a via formed therethrough to be connected to the first circuit pattern and a second circuit pattern formed on an upper surface to be connected to the via, on the first insulating layer including the first circuit pattern; cutting edge portions of the second and first insulating layers, the release film, and the adhesive layer; and removing the release film from the first insulating layer.

Here, the first conductive layer may be made of copper foil.

Further, the first conductive layer may have a size equal to or larger than that of the first insulating layer.

Further, a second conductive layer may be further stacked between the release film and the first insulating layer.

Further, the step of forming the second insulating layer, which has the via formed therethrough to be connected to the first circuit pattern and the second circuit pattern formed on the upper surface to be connected to the via, on the first insulating layer including the first circuit pattern may further include the steps of: forming the second insulating layer on the first insulating layer including the first circuit pattern; forming a via hole to open an upper surface of the first circuit pattern by removing a portion of the second insulating layer corresponding to the first circuit pattern; forming the via connected to the first circuit pattern by filling the via hole with metal; forming a conductive layer on the second insulating layer; and forming the second circuit pattern connected to the via by removing a portion of the conductive layer.

Further, after the step of removing the release film from the first insulating layer, the method may further include the steps of: forming a via hole to open the first circuit pattern by removing a portion of the first insulating layer corresponding to the first circuit pattern; and forming a surface-treated metal in the first circuit pattern opened by the via hole.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1 to 9 are process cross-sectional views for sequentially explaining a method of manufacturing a printed circuit board in accordance with an embodiment of the present invention.

### DETAILED DESCRIPTION OF THE PREFERRED EMBODIMENTS

The operation and effect and the technical constitution of a method of manufacturing a printed circuit board in accordance with the present invention to achieve the object will be clearly understood by the following detailed description with reference to the accompanying drawings in which the preferable embodiments of the present invention are shown.

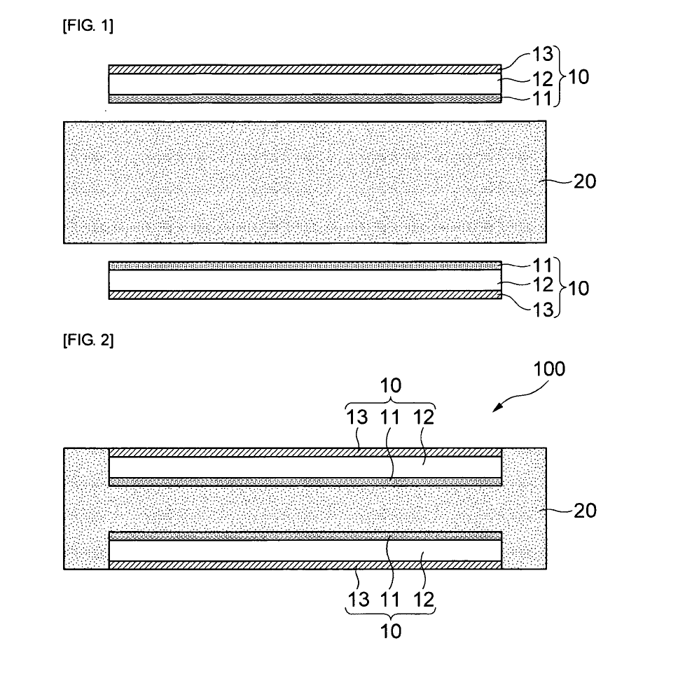

Hereinafter, a method of manufacturing a printed circuit board in accordance with an embodiment of the present invention will be explained in detail with reference to FIGS. 1 to 9.

FIGS. 1 to 9 are process cross-sectional views for sequentially explaining the method of manufacturing the printed circuit board in accordance with the embodiment of the present invention.

In the method of manufacturing the printed circuit board in accordance with the embodiment of the present invention, as shown in FIG. 1, first, a pair of raw materials 10, each of which is formed by sequentially stacking a release film 11 and a first insulating layer 12, and an adhesive layer 20 are prepared, respectively.

The adhesive layer 20, as a substrate on which a substrate is to be formed, performs a role of supporting an intermediate for forming the substrate in a transfer process between process equipment, may be made of prepreg, epoxy, Ajinomoto Build-up Film (ABF), or dry film type solder paste, and may have a thickness of approximately 0.2 to 0.3 mm.

The release film 11 and the first insulating layer 12, which constitute the raw material 10, may have a size smaller than that of the adhesive layer 20 so as to be embedded in the adhesive layer 20.

The release film 11 is used to easily separate the adhesive layer 20 and the first insulating layer 12 after completing a subsequent process of forming a multilayer circuit pattern.

Here, as shown in the drawing, the raw material 10 may further include a first conductive layer 13 stacked on the first insulating layer 12.

The first conductive layer 13 may be made of copper foil. The first conductive layer 13 may have a size equal to or larger than that of the first insulating layer 12.

Further, although it is not shown in the drawing, a second conductive layer (not shown) such as copper foil may be further stacked between the release film 11 and the first insulating layer 12.

Next, as shown in FIG. 2, a carrier 100 is formed by embedding the pair of raw materials 10, which are opposed to each other, in the adhesive layer 20 while disposing the release films 11 toward an inner layer.

In the embodiment of the present invention, the adhesive layer 20 having the raw materials 10 embedded therein is used as the carrier 100. At this time, in accordance with the embodiment of the present invention, it is possible to prevent crack generation on the first insulating layer 12 formed on the release film 11 by using the carrier 100 in which the release film 11 and the first insulating layer 12 are embedded in the adhesive layer 20.

That is, in a conventional method, cracks are generated in a corner portion of a release film due to thickness reduction of an insulating layer applied thereon by applying the insulating layer, which covers the release film, on a base layer after applying the release film, which covers a portion of a surface of the base layer, on the base layer used as a carrier. However, in the embodiment of the present invention, there is no concern about damage such as cracks to the release film 11 and the first insulating layer 12 by performing a subsequent process of forming a circuit laminate in a state in which the release film 11 and the first insulating layer 12 of the same size are embedded in the adhesive layer 20.

Therefore, in accordance with the embodiment of the present invention, it is possible to improve reliability and manufacturing yield of a product by preventing separation of the release film 11 during a manufacturing process of a coreless printed circuit board.

Then, as shown in FIG. 3, a first circuit pattern 13a is formed by removing a portion of the first conductive layer 13.

The first circuit pattern 13a may be formed by forming a photoresist pattern on the first conductive layer 13 to open a portion of the first conductive layer 13, etching the portion of the first conductive layer 13 opened by the photoresist pattern, and removing the photoresist pattern.

Here, in case that the first conductive layer 13 is not included, a process of forming the first circuit pattern 13a may be omitted.

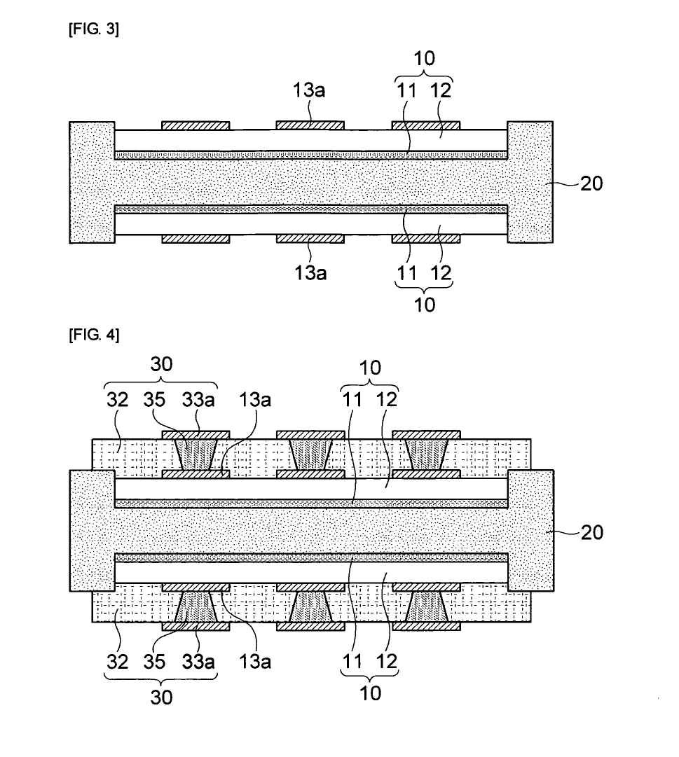

Then, as shown in FIG. 4, a first unit circuit laminate 30 is formed by forming a second insulating layer 32, which has a first via 35 formed therethrough to be connected to the first circuit pattern 13a and a second circuit pattern 33a formed on an upper surface to be connected to the first via 35, on the first insulating layer 12 including the first circuit pattern 13a.

More specifically, the first unit circuit laminate 30 may be formed by the following method.

First, the second insulating layer 32 is formed on the first insulating layer 12 including the first circuit pattern 13a.

Next, the first via 35, which is connected to the first circuit pattern 13a, is formed by removing a portion of the second insulating layer 32 corresponding to the first circuit pattern 13a through laser drilling to form a via hole opening an upper surface of the first circuit pattern 13a and filling the via hole with metal.

Then, the second circuit pattern 33a, which is connected to the first via 35, is formed by removing a portion of a conductive layer after forming the conductive layer on the second insulating layer 32 including the first via 35.

With this, the first unit circuit laminate 30 including one layer of circuit pattern is formed, and a circuit laminate including a plurality of layers of circuit patterns may be formed by repeating the above-described process.

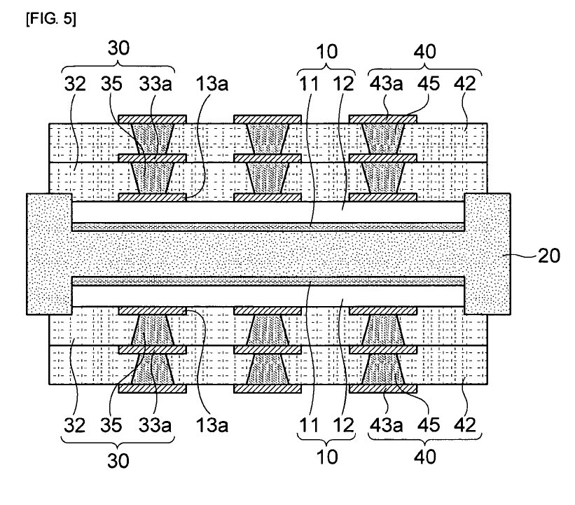

That is, by repeating the process of forming the above-described first unit circuit laminate 30, as shown in FIG. 5, a second unit circuit laminate 40 is formed by forming a third insulating layer 42, which has a second via 45 formed therethrough to be connected to the second circuit pattern 33a and a third circuit pattern 43a formed on an upper surface to be connected to the second via 45, on the second insulating layer 32 including the second circuit pattern 33a. A process of forming the second unit circuit laminate 40 may be omitted.

As described above, in case of using the raw material 10 including the release film 11, the first insulating film 12, and the first conductive layer 13, a circuit laminate including three layers of circuit patterns, that is, the first, second, and third circuit patterns 13a, 33a, and 43a can be obtained by performing the process of forming the unit circuit laminate twice.

That is, the printed circuit board is formed by preparing the carrier 100 in which the release film 11, the first insulating layer 12, and the first conductive layer 13 are embedded in the adhesive layer 20, forming the first conductive layer 13 embedded in the carrier 100 into the first circuit pattern 13a, and performing the subsequent process of forming the unit circuit laminate. In this case, since the carrier 100 already has one conductive layer 13, it is unnecessary to form a conductive layer by additional plating. Thus, there is an advantage of simplifying a manufacturing process of a multilayer printed circuit board.

In the embodiment of the present invention, although it is shown and explained that the three layers of circuit patterns 13a, 33a, and 43a are formed by repeatedly performing the process of forming the unit circuit laminate twice, the three layers of circuit patterns are just used for convenience of explanation, but it is not limited to thereto.

Meanwhile, in case that the first conductive layer 13 is not included in the raw material 10, the first unit circuit laminate 30 is formed by forming the second insulating layer 32, which has the first via 35 formed therethrough and the second circuit pattern 33a formed on the upper surface to be connected to the first via 35, on the first insulating layer 12. More specifically, the first unit circuit laminate 30 may be formed by the following method. The first via 35 is formed by forming the second insulating layer 32 on the first insulating layer 12, removing a portion of the second insulating layer 32 through laser drilling to form a via hole opening a portion of the upper surface of the first insulating layer 12, and filling the via hole with metal. Next, the second circuit pattern 33a, which is connected to the first via 35, is formed by forming the conductive layer on the second insulating layer 32 including the first via 35 and removing the portion of the conductive layer.

With this, the first unit circuit laminate 30 including one layer of circuit pattern is formed. The circuit laminate including a plurality of layers of circuit patterns may be formed by repeating the above-described process.

That is, by repeating the above-described process of forming the first unit circuit laminate 30, the second unit circuit laminate 40 is formed by forming the third insulating layer 43, which has the second via 45 formed therethrough to be connected to the second circuit pattern 33a and the third circuit pattern 43a formed on the upper surface to be connected to the second via 45, on the second insulating layer 32 including the second circuit pattern 33a.

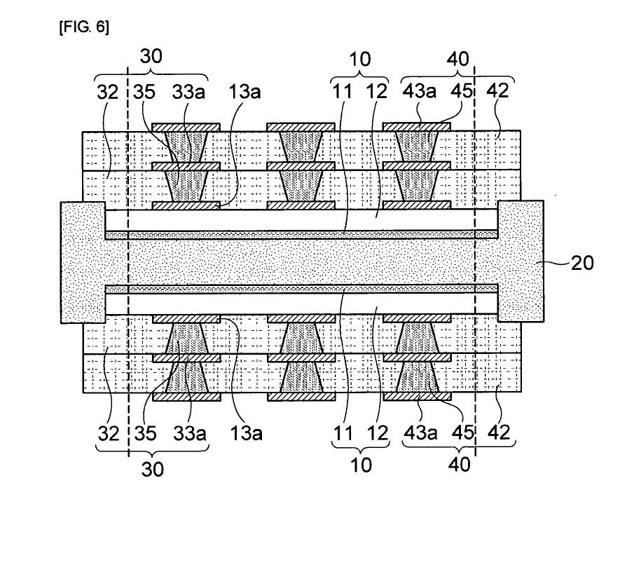

Next, as shown in FIG. 6, edge portions of the third, second, and first insulating layers 42, 32, and 12, the release film 11, and the adhesive layer 20 are cut.

Cut boundaries of the third, second, and first insulating layers 42, 32, and 12, the release film 11, and the adhesive layer 20 are shown in dotted lines. A cutting process may be performed by physically cutting the third, second, and first insulating layers 42, 32, and 12, the release film 11, and the adhesive layer 20.

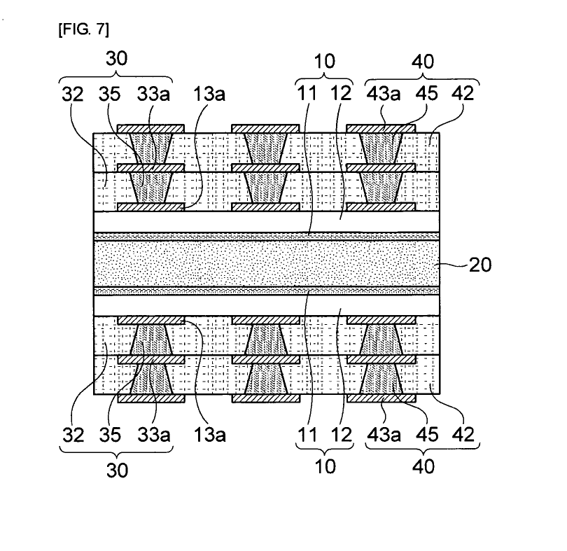

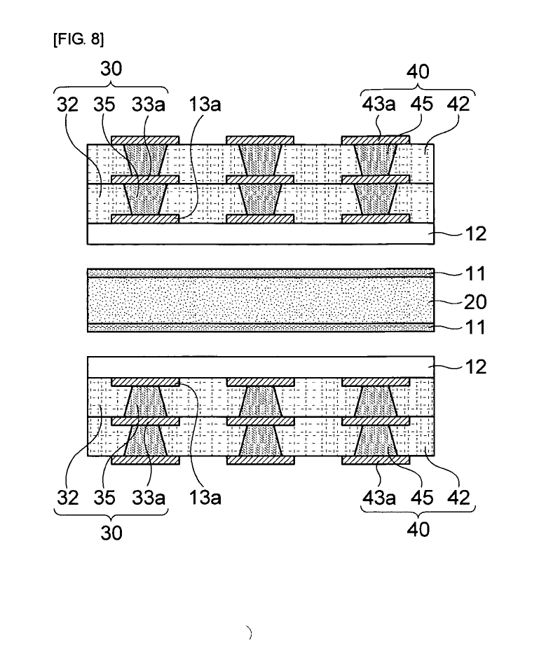

After completing the cutting process as shown in FIG. 7, as shown in FIG. 8, the adhesive layer 20 is removed from the first insulating layer 12 by removing the release film 11 from the first insulating layer 12.

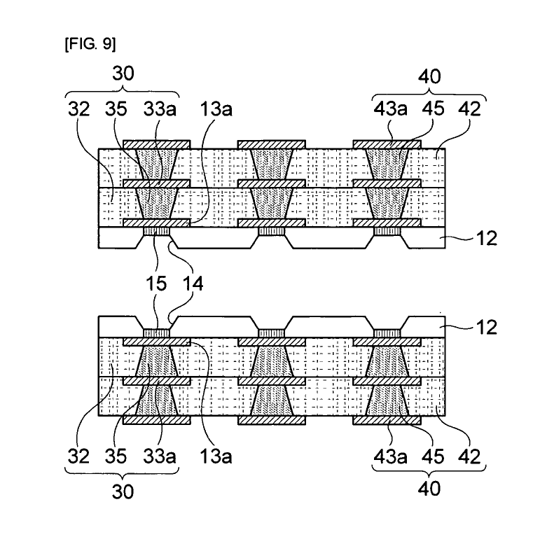

Then, as shown in FIG. 9, a via hole 14 is formed to open the first circuit pattern 13a by removing a portion of the first insulating layer 12, from which the release film 11 is removed, corresponding to the first circuit pattern 13a. A process of opening the via hole 14 may be performed by an etching or laser drilling method.

Next, a surface-treated metal 15 is formed in the first circuit pattern 13a opened by the via hole 14. The surface-treated metal 15 may include Au.

Meanwhile, in case that the first circuit pattern 13a is not formed, the surface-treated metal 15 is formed in the first via 35 opened by the via hole 14 after forming the via hole 14 to open the first via 35 by removing the portion of the first insulating layer 12, from which the release film 11 is removed, corresponding to the first via 35.

As described above, in accordance with the method of manufacturing the printed circuit board of the present invention, in manufacturing a coreless substrate, it is possible to prevent the crack generation on the insulating layer formed on the release film by using the carrier in which the release film and the insulating layer are embedded in the adhesive layer. Moreover, since the release film is embedded in the adhesive layer, it is possible to stably maintain adhesion between the release film and the insulating layer even though an impact is applied to the substrate.

Therefore, the present invention can prevent the separation of the release film during a substrate manufacturing process and improve the reliability and manufacturing yield of the product.

Further, the present invention can manufacture the printed circuit board by preparing the carrier in which the release film, the insulating layer, and the conductive layer are embedded in the adhesive layer, forming the conductive layer embedded in the carrier into the circuit pattern, and performing the subsequent process of forming the insulating layer and the circuit pattern. In this case, since the carrier already has one conductive layer, it is unnecessary to form the conductive film by additional plating, thereby simplifying the manufacturing process of the multilayer printed circuit board.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of manufacturing a printed circuit board comprising:
preparing a pair of raw materials, each formed by sequentially stacking a release film and a first insulating layer, and an adhesive layer, respectively;
embedding the pair of raw materials, which are opposed to each other, in the adhesive layer while disposing the release films toward an inner layer;
forming a second insulating layer, which has a via formed therethrough and a circuit pattern formed on an upper surface to be connected to the via, on the first insulating layer;
cutting edge portions of the second and first insulating layers, the release film, and the adhesive layer; and
removing the release film from the first insulating layer.

2. The method according to claim 1, wherein the raw material has a size smaller than that of the adhesive layer.

3. The method according to claim 1, wherein forming the second insulating layer, which has the via formed therethrough and the circuit pattern formed on the upper surface to be connected to the via, on the first insulating layer comprises:
forming the second insulating layer on the first insulating layer;
forming a via hole to open a portion of an upper surface of the first insulating layer by removing a portion of the second insulating layer;
forming the via by filling the via hole with metal;
forming a conductive layer on the second insulating layer including the via; and
forming the circuit pattern connected to the via by removing a portion of the conductive layer.

4. The method according to claim 1, after removing the release film from the first insulating layer, further comprising:
forming a via hole to open the via by removing a portion of the first insulating layer corresponding to the via; and
forming a surface-treated metal in the via opened by the via hole.

5. The method according to claim 4, wherein the surface-treated metal includes Au.

6. A method of manufacturing a printed circuit board comprising:
preparing a pair of raw materials, each formed by sequentially stacking a release film, a first insulating layer, and a first conductive layer, and an adhesive layer, respectively;
embedding the pair of raw materials, which are opposed to each other, in the adhesive layer while disposing the release films toward an inner layer;
forming a first circuit pattern by removing a portion of the first conductive layer;
forming a second insulating layer, which has a via formed therethrough to be connected to the first circuit pattern and a second circuit pattern formed on an upper surface to be connected to the via, on the first insulating layer including the first circuit pattern;
cutting edge portions of the second and first insulating layers, the release film, and the adhesive layer; and
removing the release film from the first insulating layer.

7. The method according to claim 6, wherein the first conductive layer is made of copper foil.

8. The method according to claim 6, wherein the first conductive layer has a size equal to or larger than that of the first insulating layer.

9. The method according to claim 6, wherein a second conductive layer is further stacked between the release film and the first insulating layer.

10. The method according to claim 6, wherein forming the second insulating layer, which has the via formed therethrough to be connected to the first circuit pattern and the second circuit pattern formed on the upper surface to be connected to the via, on the first insulating layer including the first circuit pattern comprises:
forming the second insulating layer on the first insulating layer including the first circuit pattern;
forming a via hole to open an upper surface of the first circuit pattern by removing a portion of the second insulating layer corresponding to the first circuit pattern;
forming the via connected to the first circuit pattern by filling the via hole with metal;
forming a conductive layer on the second insulating layer; and
forming the second circuit pattern connected to the via by removing a portion of the conductive layer.

11. The method according to claim 6, after removing the release film from the first insulating layer, further comprising:
forming a via hole to open the first circuit pattern by removing a portion of the first insulating layer corresponding to the first circuit pattern; and
forming a surface-treated metal in the first circuit pattern opened by the via hole.
